(19) United States
(12) Patent Application Publication
(10) Pub. No.: US 2021/0258462 A1
(43) Pub. Date: Aug. 19, 2021

(54) DEVICE FOR SUPPORTING A SMARTPHONE OR CAMERA

(71) Applicants: Tim Goldburt, Elmsford, NY (US); Matt Sandy, Elmsford, NY (US)

(72) Inventors: Tim Goldburt, Elmsford, NY (US); Matt Sandy, Elmsford, NY (US)

(21) Appl. No.: 16/726,236

(22) Filed: Dec. 23, 2019

(51) Int. Cl. H04N 5/232; H04M 1/04; H04N 5/225; H04R 1/02

(52) U.S. Cl. CPC H04N 5/2328; H04R 1/028; H04N 5/22525; H04M 1/04

(57) ABSTRACT

A device for supporting a smartphone having a camera or supporting an action camera has a holder configured for supporting a smartphone having a camera or supporting an action camera, a handle configured to be held by a user, and components for receiving audio signals from an audio signal source and reproducing the received audio signals in the vicinity of the handle.

### BACKGROUND OF THE INVENTION

The present invention relates to devices for supporting a target object, in particular a smartphone having a camera in it and adjusting its position, for example the orientation, the panning movement, the rolling movement and the pitching movement, to achieve a stable and smooth shooting at multiple angles; or for supporting a camera such as a video camera, a photo camera, an action camera and adjusting its position, for example the orientation, the panning movement, the rolling movement and the pitching movement, to achieve a stable and smooth shooting at multiple angles.

Current devices of this type, also known as stabilizers or gimbals, for smartphones or cameras are designed to function so that when they support smartphones having a camera in them or when they support a camera they provide smooth shooting and various methods of video recording, including, but not limited to, motion time lapse, stable vertical video shooting for social media vertical video format, and added software app functions such as facial and object tracking. The current devices of this type of stabilizers in the market do not however have capabilities for receiving audio signals from audio sources and reproducing them in the vicinity of the device and therefore in the vicinity of a supported smartphone with a camera or a supported camera before, during or after recording by a supported camera.

### SUMMARY OF THE INVENTION

Accordingly it is an object of the present invention to provide a device for supporting a target object, in particular for supporting a smartphone having a camera in it, or for supporting a camera, and adjusting its position to achieve a stable and smooth shooting, which avoids the disadvantages of the prior art devices for supporting the target object.

In keeping with these objectives and with others which will become apparent hereinafter, one feature of the present invention resides, briefly stated in a device for supporting a smartphone having a camera or for supporting an action camera, which has a support configured for supporting a smartphone with a camera or for supporting an action camera, a handle configured to be held by a user, and means for receiving audio signals from an audio signal source and reproducing the received audio signals in the vicinity of the handle.

When the device for supporting a smartphone having a camera or supporting an action camera is designed in accordance with the present invention, it not only supports a target object, in particular a smartphone with a camera or just a camera, and adjusts its position to achieve a stable and smooth shooting, but at the same time it allows to receive audio signals from audio sources and to reproduce them in the vicinity of the handle and also in the vicinity of a supported smartphone with a camera or of supported cameras before, during or after recording by the camera.

According to a further feature of the present invention the device for supporting a smartphone having a camera or supporting an action camera of the invention further has at least two motors arranged between the handle and the holder and operative for moving the holder and thereby the smartphone with the camera or moving the camera supported by the holder relative to the handle for stabilizing the position of the smartphone with the camera or a position of the camera for stable and smooth movement recording at multiple angles.

According to a further feature of the present invention the device for supporting a smartphone having a camera or for supporting an action camera of the invention further has means for selecting the outside audio signal source for receiving the audio signals from the selected outside audio signal source and reproducing the received audio signal in the vicinity of the handle.

Still a further feature of the present invention resides in the device for supporting a smartphone with a camera or for supporting an action camera of the invention further has means for adjusting an intensity of the reproducing of the received audio signals from the selected outside audio signal source in the vicinity of the handle.

A further feature of the present invention resides in that the device has a screen display for showing wavelengths of the audio signals, adjusting buttons for adjusting a volume of received radio signals up and down correspondingly, a knob for switching between AM radio waves and FM radio waves of the audio signals, knobs for dialing a corresponding wavelength within an AM and FM ranges of the audio signals and for adjusting the volume of a speaker which generates corresponding audio signals.

A further feature of the present invention resides in that in the device the means can include an AM receiver, an FM receiver, an AM transmitter, an FM transmitter, and a speaker. Also, the means can include an antenna for transmitting and receiving radio signals, a receiver circuitry and a transmitter circuitry both connected to a processor circuitry, and a control processor which controls the operation of said means, a microphone, a keypad, and a display.

A further feature of the present invention resides in that in that the handle is provided with an opening for attaching the device to a support and having an inner thread for screwing in a threaded end of the support, and the opening is provided in a part connectable with a remaining part of the handle by a threaded connection.

A further feature of the present invention resides in that the device has a part with a threaded portion provided with an outer thread and screwable into a lower part of the handle which is hollow and provided with an inner thread, and the handle has an inner opening which is exposed when the part is unscrewed and removed from a remaining part of the handle and which is exposed for inserting of a battery.

A further feature of the present invention resides in that in the device the handle is connected with remaining components of the device via a multi-part telescoping connecting unit composed of a plurality of handle elements which are telescopingly connectable with one another and are displaceable relative to one another, so that by extending or retracting of the telescoping connecting unit a distance of the holder from the handle can be reduced or increased.

A further feature of the present invention resides in that the device has a tilting motor and a rolling motor applying correspondingly a tilting movement and a rolling movement to the holder, and a foldable arm having one end connected with the tilting motor and another opposite end pivotable connected with the pan or yaw motor so that the device can be folded to occupy a substantially small space, which can be convenient for its storage and transportation.

A further feature of the present invention resides in that in the device has a multi-part telescoping connecting unit composed of a plurality of elements which are telescopingly connectable with one another and are displaceable relative to one another and connects the handle with the pan or yaw motor so that by extending or retracting of the telescopingly connecting unit a distance of the holder to the handle can be reduced or increased, and also has a foldable arm with one end connected with the tilting motor and another opposite end pivotable connected with the pan or yaw motor, so that the device can be folded so as to occupy a substantially small space which can be convenient for its storage and transportation.

A further feature of the present invention resides in that the handle has a substantially rectangular cross section and an additional portion provided with components which allow receiving audio signals from audio sources and reproducing them in the vicinity of the handle and therefore also in the vicinity of a supported smartphone with a camera or of a supported camera before, during and after during recording by the camera.

A further feature of the present invention resides in that in the device the holder includes a housing which has an additional portion provided with components which allow receiving audio signals from audio sources and reproducing them in the vicinity of the handle and therefore in the vicinity of a supported smartphone with a camera or of a supported camera before, during and after recording by the camera, and the housing is supported on a tripod with adjustable legs and connected with the housing via a ball joint and fixed by a screw in its desired position.

A further feature of the present invention resides in that the handle is provided with an on/off power button for turning the operation of the device on or off, a joystick button for controlling the movement of the smartphone camera or the action camera, an orientation button for orienting the smartphone with the camera or orienting the action camera, a button for operating corresponding modes, and a button for video and photo recording of the smartphone that can be connected via bluetooth to wirelessly control the smartphone camera recording, and the handle is supported on a tripod with adjustable legs and connected with the housing via a ball joint and fixed by a screw in its desired position.

A further feature of the present invention resides in that in the device the handle has an on/off power button for turning the operation of the device on or off, a joystick button for controlling a video recording and movement of the smartphone camera or the action camera, an orientation button for orienting the smartphone or the action camera, a button for operating corresponding modes, and a button for video and photo recording, and the handle is connected with a telescoping extension support which can be held by a user and is composed of interconnected components which are movable toward one another and away from one another to reduce or to increase the length of the support, for convenience of user's operation with the smartphone with a camera or with an action camera received in the holder.

A further feature of the present invention resides in that in the device the handle is telescoping and has a plurality of individual portions telescopingly connected with each other to increase or reduce the length of the handle, with the individual portion which is the closest to the holder having an element which is turnably connected with an element supporting the holder.

A further feature of the present invention resides in that in the device has a camera with an objective and a viewfinder display, and the handle is formed as a casing with a portion provided with the components which allow receiving audio signals from audio sources and reproducing them in the vicinity of the device before, during and after recording by the supported camera.

A further feature of the present invention resides in that the handle has a portion provided with components which allow receiving audio signals from audio sources and reproducing them in the vicinity of the device and designed for supporting of the camera which is a large camera.

A further feature of the present invention resides in that the device is formed as a pocket-size device with a casing which forms the handle, a viewfinder with a touch screen and an objective, a rolling motor, a tilting motor, and pan or yaw motor for imparting corresponding movements to an objective of the camera, and the casing has a portion provided with the components which allow receiving audio signals from audio sources and reproducing them in the vicinity of the device, and a lower portion with a thread for connecting to a support.

The novel features of the present invention are set forth in particular in the appended claims. The invention itself however will be best understood from the following description of the preferred embodiments, which is accompanied by the following drawings.

### BRIEF DESCRIPTION OF THE DRAWINGS

FIG. 1 is a view showing a known device for supporting a smartphone having a camera or an action camera; and

FIG. 1a-16 are views showing details and different embodiments of the device for supporting a smartphone having a camera or an action camera according to the present invention.

### DESCRIPTION OF THE PREFERRED EMBODIMENTS

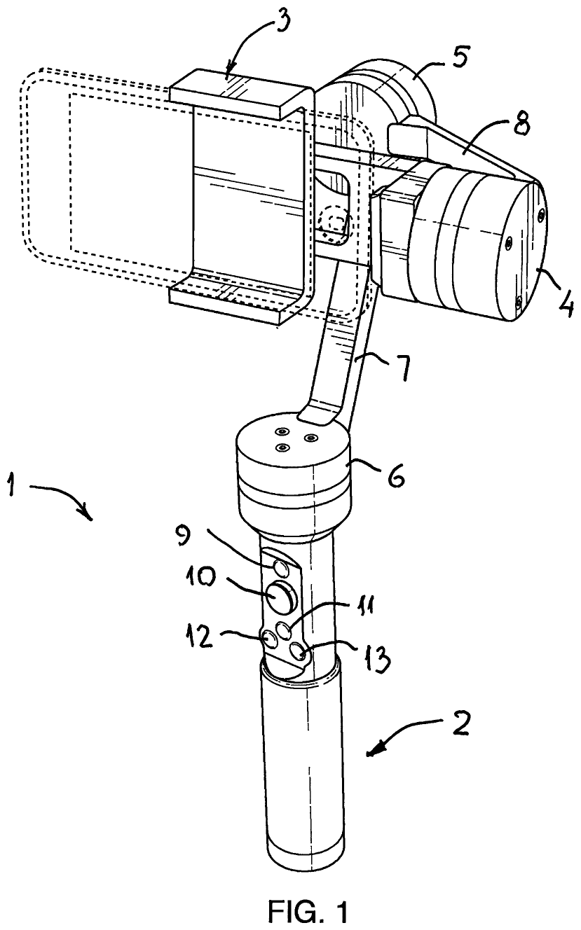

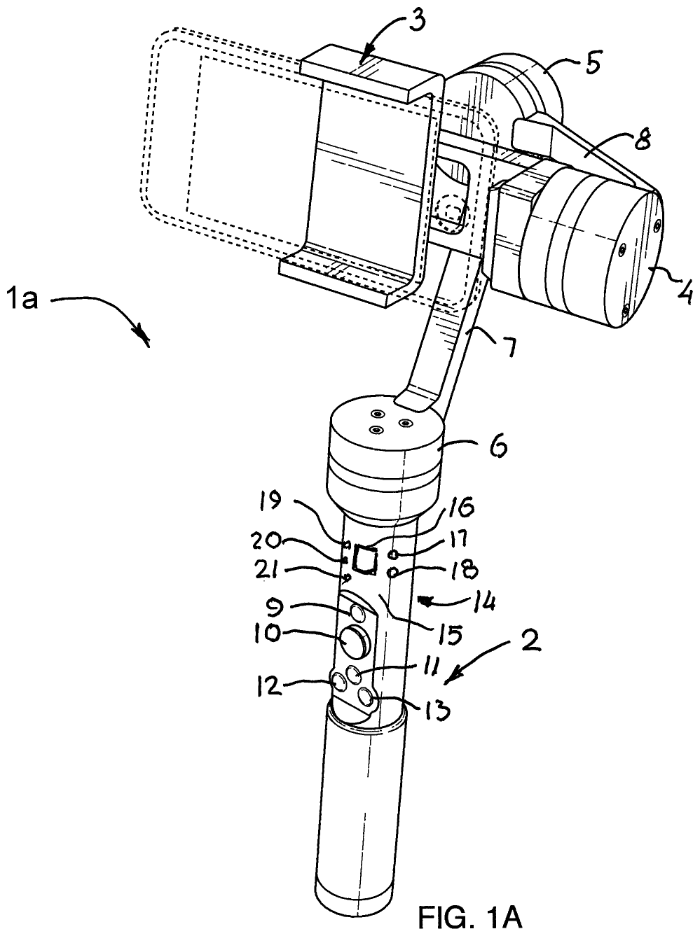

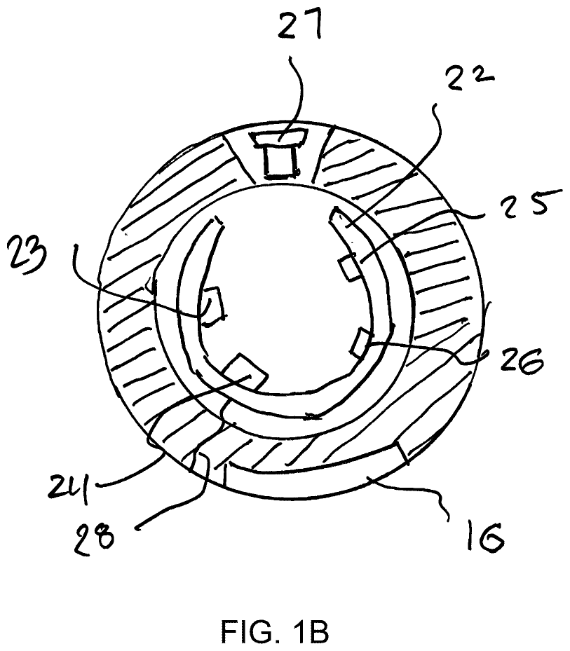

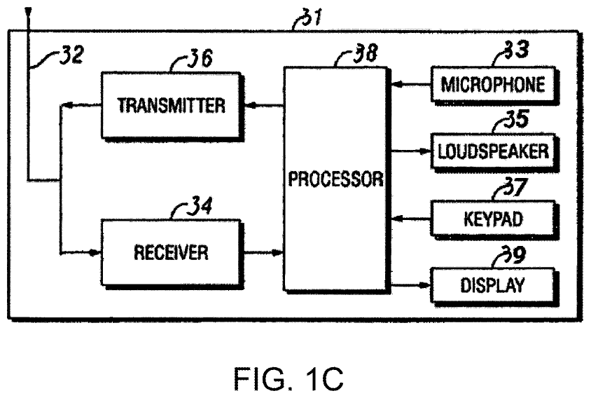

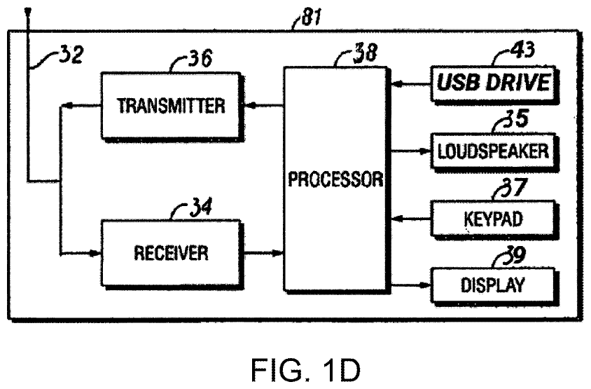

FIG. 1 of the drawings shows a perspective view of a known device 1 for supporting a smartphone having a camera or an action camera. The supporting device 1 has a handle 2 adapted to be held by a user and connected with a holder 3 for receiving and holding a not shown smartphone with a camera or holding an action camera. It further has a tilting motor 4, a rolling motor 5, and pan or yaw motor 6 for imparting corresponding movements to the holder 3 and thereby to a smartphone with a camera or an action camera held in the holder 3. Arms 7 and 8 connect the corresponding motors with one another.

The handle 2 is provided with an on/off power button 9 for turning the operation of the device 1 on or off, a joystick button 10 for controlling a video recording of and movement of the camera of the smartphone or the action camera, an orientation button 11 for orienting the smartphone with the camera or the action camera, a button 12 for operating corresponding modes, and a button 13 for video and photo recording.

A device 1a designed according to the present invention is shown in FIG. 1A. It corresponds to the known device in that it can be provided with some or all above described components. The device according to the invention further has novel components and operates in a novel manner, which will now be described in detail.

In the device 1a for supporting a smartphone having a camera or supporting an action camera according to the invention the handle 2 has an additional portion which is identified with reference numeral 14 and provided with components 15 allowing receiving audio signals from audio sources and reproducing them in the vicinity of the handle of the device and therefore in the vicinity of a supported smartphone with a camera or of a supported camera before, during and after a recording by the camera.

The device 1a has a screen display 16 for showing wavelengths of the radio and/or video signals, adjusting buttons 17 and 18 for adjusting a volume of received radio signals up and down correspondingly, a knob 19 for switching between AM radio waves and FM radio waves, a knob 20 for dialing a corresponding wavelength within an AM and FM ranges, a knob 21 for adjusting a volume of a speaker which generates corresponding audio signals.

FIG. 1B shows a cross section of the handle 2 in the area 14 accommodating the means 15. This area of the handle contains a flexible PCB 22, an AM receiver 23, an FM receiver 24, an AM transmitter 25, an FM transmitter 26, a speaker 27. Corresponding lead wires are identified with reference numerals 28.

A user of the device 1a for supporting a smartphone having a camera or supporting an action camera designed in correspondence with this embodiment of the present invention, in addition to supporting of a smartphone with a camera or supporting an action camera and adjusting their orientation and providing smooth stable movement video recording, can operate the above identified elements of the means 15 so as to receive audio and video signals from a signal source via the receivers 23 and 24, transmit the received audio and/or video signals in the vicinity of handle 2 of the supporting device 1 via the transmitters 25 and 26, and reproduce the audio signals via the speaker 27.

FIG. 1C of the drawings shows a schematic block diagram of the device for supporting a smartphone having a camera or supporting a camera in accordance with the present invention. The device is identified as a whole with reference numeral 31 and has an antenna 32 which is used for transmitting and receiving radio signals. The received signals are passed to a receiver circuitry 34, while the transmitted signals are sent to the antenna 32 from a transmitter circuitry 36. The receiver circuitry 34 and the transmitter circuitry 36 are both connected to a processor circuitry 38 which, in this case, is used to represent both a signal processing circuitry and a control processor which controls the operation of the device. The processor circuitry 38 can receive audio inputs from a microphone 33, and an alphanumeric or other inputs from a keypad 37, and provide audio outputs through a loudspeaker 35 and visual outputs through a display 39.

FIG. 1D of the drawings shows a schematic block diagram of the device for supporting a smartphone having a camera or supporting a camera in accordance with another aspect of the present invention. In particular it shows a portable communication apparatus in which the present invention can be applied. The device is identified as a whole with reference numeral 81 and has an antenna 32 which is used for transmitting and receiving radio signals. The received signals are passed to a receiver circuitry 34, while the transmitted signals are sent to the antenna 32 from a transmitter circuitry 36. The receiver circuitry 34 and the transmitter circuitry 36 are both connected to a processor circuitry 38 which, in this case, is used to represent both a signal processing circuitry and a control processor which controls the operation of the device. The processor circuitry 38 can receive audio inputs from a USB flash drive 43 for inserting USB flash drive with a digital mp3 music files playlist, and an alphanumeric or other inputs from a keypad 37, and provide audio outputs through a loudspeaker 35 and visual outputs through a display 39.

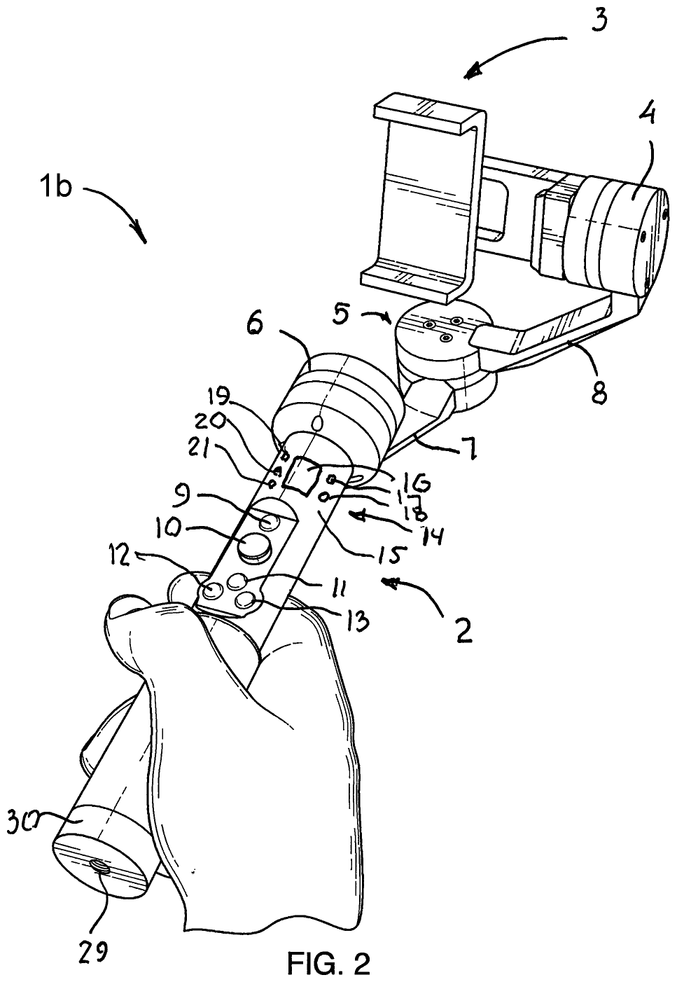

FIG. 2 of the drawings shows the device for supporting a smartphone having a camera or supporting a camera in accordance with further features of the present invention. It includes the components shown in FIGS. 1A and 1B and at the same time it has additional novel features. In the device shown in FIG. 2 the handle 2 in its end which is opposite to the holder 3 is provided with an opening 29 for attaching the device to a not shown support, such as a monopod, a tripod or the like. The opening 29 can be provided with an inner thread for screwing in a corresponding threaded end of such a support. The opening 29 can be provided in a part 30 connectable with a remaining part of the handle 2, for example also by a threaded connection.

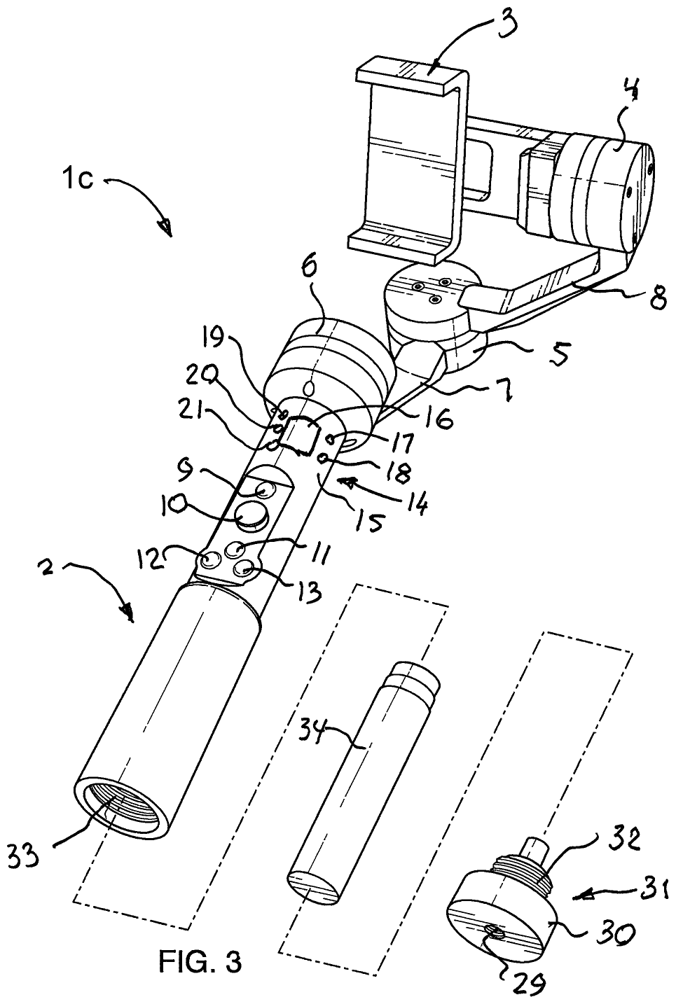

FIG. 3 of the drawings shows the device for supporting a smartphone with a camera or supporting a camera in accordance with further features of the present invention. It includes the components shown in FIGS. 1A, 1B and 2 and at the same time it has additional novel features. In the device shown in FIG. 3 the part 30 which has a threaded portion 31 is provided with an outer thread 32. It can be screwed into the lower part of the handle 2 which is hollow and provided with an inner thread 33. When the part 30 is unscrewed and removed from a remaining part of the handle 2, an inner opening in the handle is exposed and a replaceable battery 34 can be inserted into the hollow handle, with the subsequent threaded connection of the part 30 to the remaining part of the handle 2 to close the inner opening. While FIG. 3 shows that the device for supporting a smartphone with a camera or supporting a camera of the invention is battery operated, and possibly with the rechargeable battery, the device can be designed so that it can be rechargeable from an outside current source without any need from a battery.

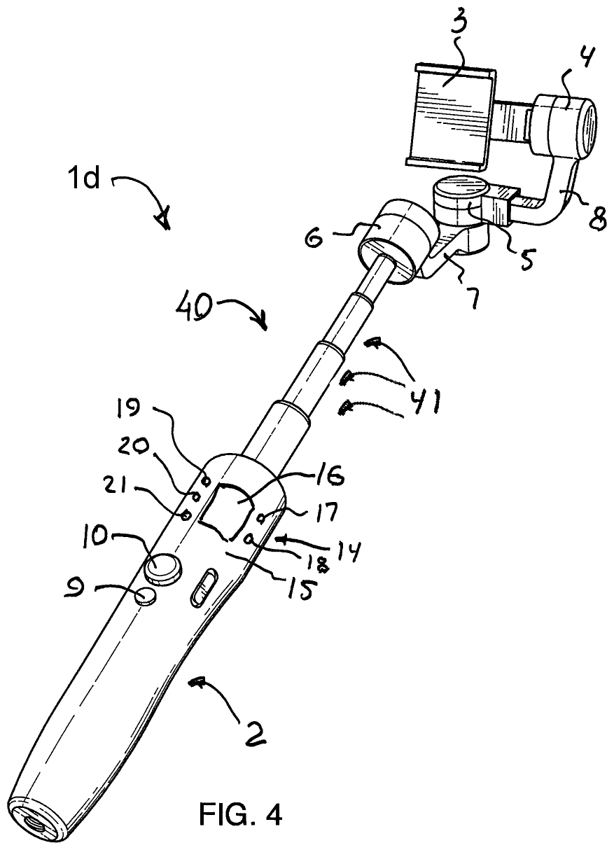

FIG. 4 of the drawings shows the device for supporting a smartphone having a camera or supporting a camera in accordance with a further feature of the present invention. It includes the components shown in FIGS. 1A and 1B and at the same time it has additional novel features. In the device shown in FIG. 4 the handle 2 is connected with remaining components of the device via a multi-part telescoping connecting unit 40 composed of a plurality of handle elements 41 which are telescoping connectable with one another and are displaceable relative to one another. More particularly, while one end of the telescoping connecting unit 40 is connected with the handle 2, its opposite end is connected with the pan or yaw motor 6. As a result by extending or retracting of the telescoping connecting unit 40 a distance of the holder 3 with a not shown smartphone with a camera or with an action camera from the handle 2 can be reduced or increased depending on a user's preference.

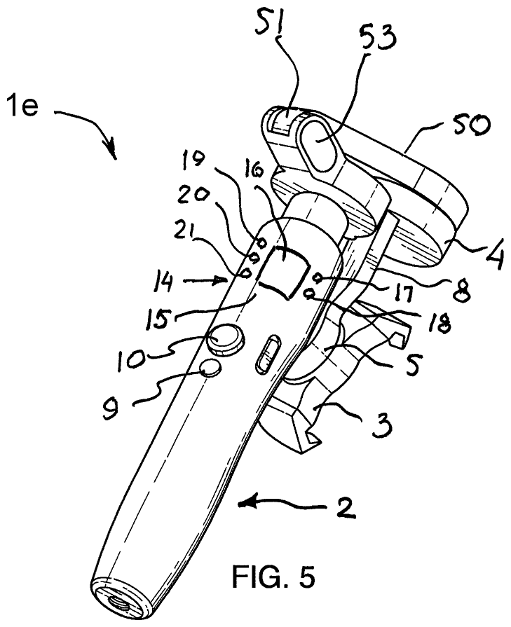

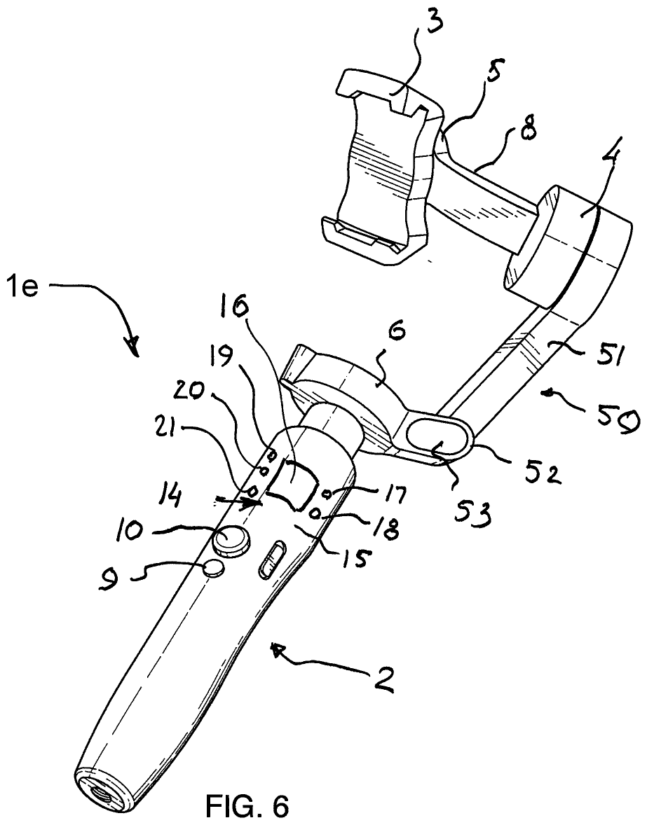

FIGS. 5 and 6 of the drawings show the device for supporting a smartphone having a camera or supporting a camera in accordance with a further feature of the present invention. It includes the components shown in FIGS. 1A and 1B and at the same time has additional novel features. In the device shown in FIGS. 5 and 6 a foldable arm 50 is provided. The foldable arm 50 has one end 51 connected with the tilting motor 4 and another opposite end 52 which is pivotable connected with the pan or yaw motor 5, with covers 53 covering opposite axial ends of the pivotal connection. As shown in this figure, the device can be folded so as to occupy a substantially small space, which can be convenient for its storage and transportation.

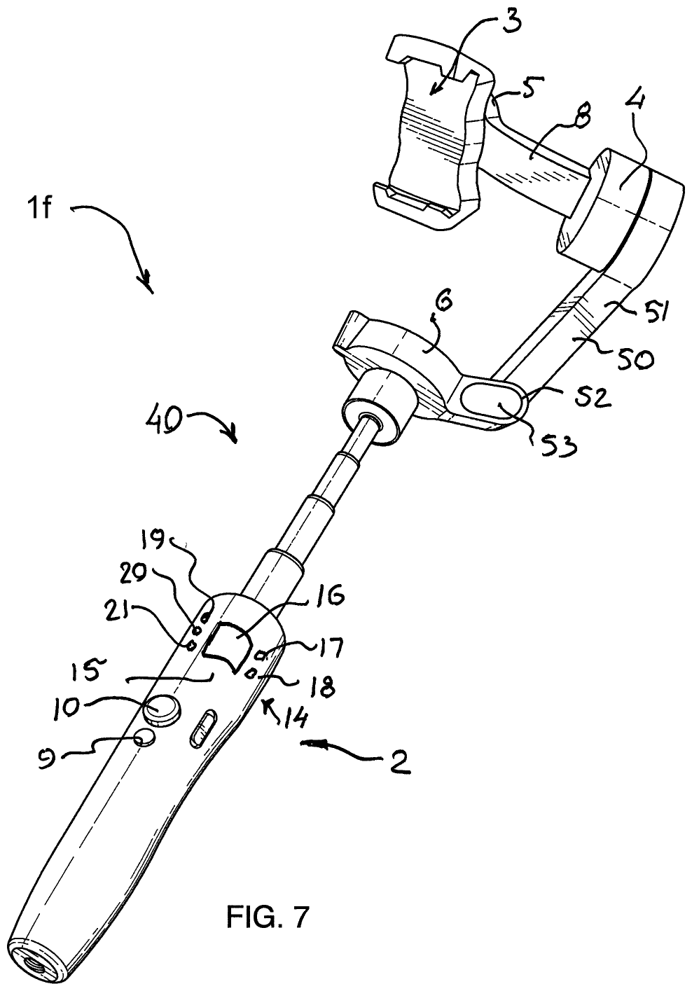

FIG. 7 of the drawings shows the device for supporting a smartphone having a camera or supporting a camera in accordance with a further feature of the present invention. The supporting device 1f has a handle 2 adapted to be held by a user and connected with a holder 3 for receiving and holding a not shown smartphone with a camera or holding an action camera. It further has a tilting motor 4, a rolling motor 5, and pan or yaw motor 6 for imparting corresponding movements to the holder 3 and thereby to a smartphone with the camera or to an action camera held in the holder 3. A multi-part telescoping connecting unit 40 is provided and composed of a plurality of handle elements 41 which are telescopingly connectable with one another and are displaceable relative to one another connects the handle 2 with the pan or yaw motor 6. As a result, by extending or retracting of telescoping connecting unit 40 a distance of the holder 3 and thereby of a not shown smartphone with a camera or of an action camera received in it from the handle 2 can be reduced or increased depending on a user's preference. A foldable arm 50 is further provided and has one end 51 connected with the tilting motor 4 and another opposite end 52 which is pivotable connected with the pan or yaw motor 6, with covers 53 covering opposite axial ends of the pivotal connection. As a result, the device can be folded so as to occupy a substantially small space, which can be convenient for its storage and transportation.

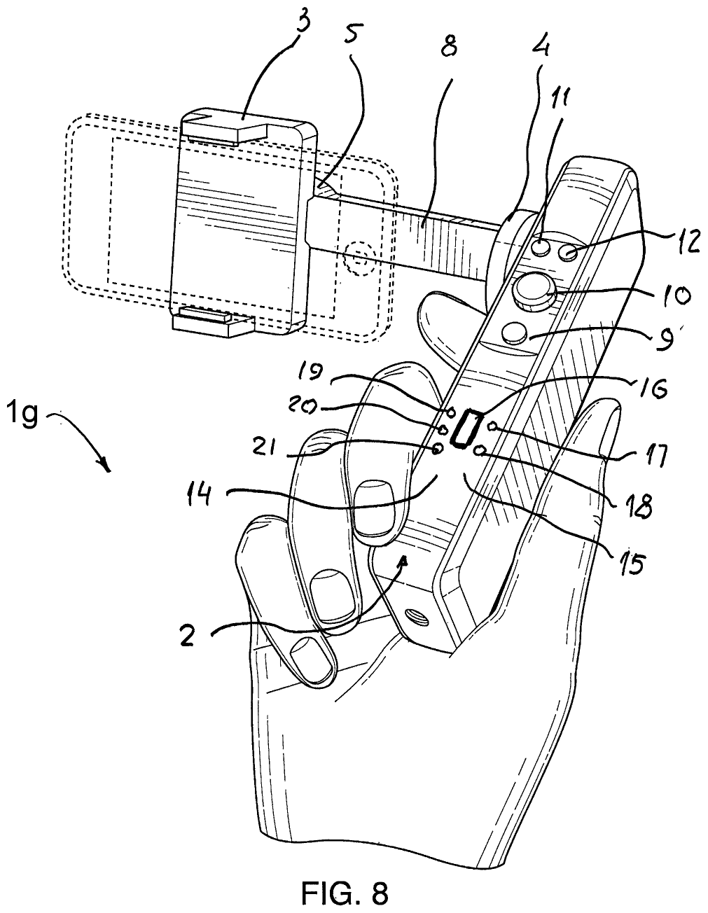

FIG. 8 of the drawings shows the device for supporting a smartphone having a camera or supporting a camera in accordance with a further feature of the present invention, The supporting device 1g has a handle 2 adapted to be held by a user and connected with a holder 3 for receiving and holding a not shown smartphone with a camera or an action camera. It further has a rolling motor 5 and a tilting motor 4 for imparting corresponding movements to the holder 3 and thereby to a smartphone with a camera or to an action camera held in the holder 3. The handle 2 in the embodiment has a substantially rectangular cross section. Similarly to the embodiment of FIGS. 1A and 1B, it has an additional portion which is identified with reference numeral 14 and provided with components 15 which allow receiving audio signals from audio sources and reproducing them in the vicinity of the device and therefore in the vicinity of a supported smartphone with a camera or of a supported camera before, during and after recording by the supported camera.

FIG. 9 of the drawings shows the device for supporting a smartphone having a camera or supporting a camera in accordance with a further feature of the present invention. The supporting device 1h has a handle 2 adapted to be held by a user and connected with a holder 3 for receiving and holding a not shown smartphone with a camera or an action camera. The holder 3 includes a housing 60 that has an additional portion which is identified with reference numeral 14 and is provided with components 15 which allow receiving audio signals from audio sources and reproducing them in the vicinity of the handle of the device and therefore in the vicinity of a supported smartphone with a camera or of a supported camera before, during and after recording by the camera. The housing 60 is supported on a tripod 61 with adjustable legs 62. The holder 3 is connected with the housing 60 via a ball joint 64 and fixed by a screw 63 in its desired position.

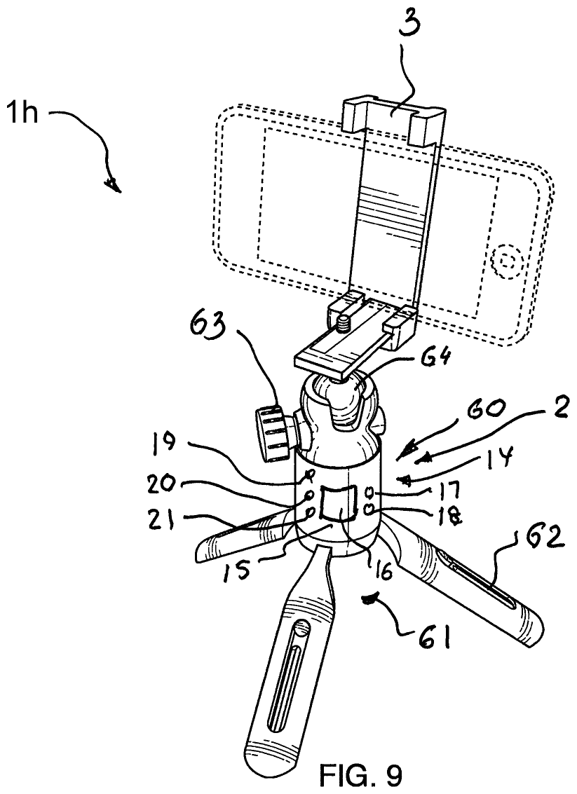

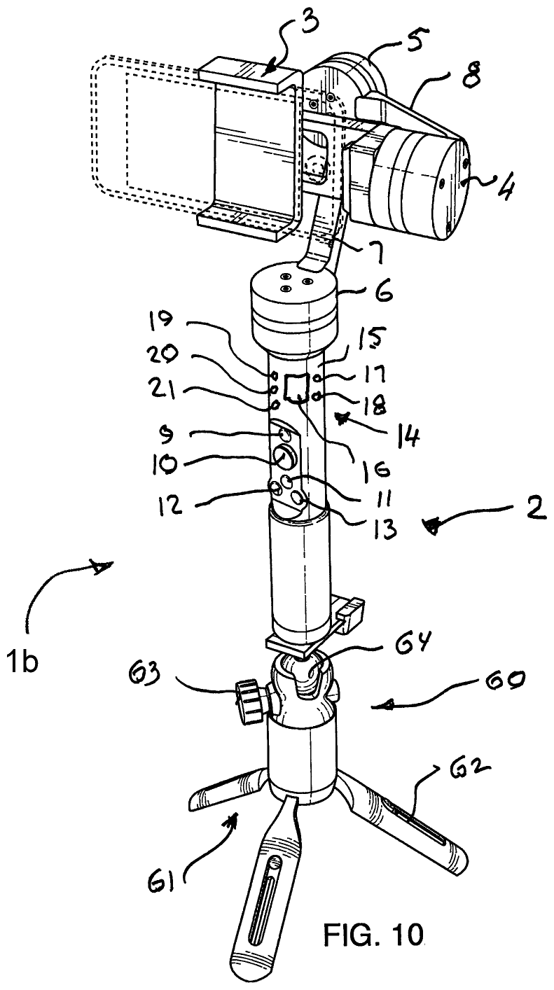

FIG. 10 of the drawings shows the device for supporting a smartphone having a camera or supporting a camera in accordance with a further feature of the present invention. The supporting device 1b has a handle 2 adapted to be held by a user and connected with a holder 3 for receiving and holding a not shown smartphone with a camera or an action camera. It further has a rolling motor 5, a tilting motor 4, and pan or yaw motor 6 for imparting corresponding movements to the holder 3 and thereby to a smart phone or an action camera held in the holder 3. Arms 7 and 8 connect the corresponding motors with one another. The handle 2 is provided with an on/off power button 9 for turning the operation of the device 1 on or off, a joystick button 10 for controlling a video recording of the smartphone with a camera or the action camera, an orientation button 11 for orienting the smartphone or the action camera, a button 12 for operating corresponding modes, and a button 13 for video and photo recording. The handle 2 is supported on a tripod 61 with adjustable legs 62. The handle 2 is connected with the housing 60 via a ball joint 64 and fixed by a screw 63 in its desired position.

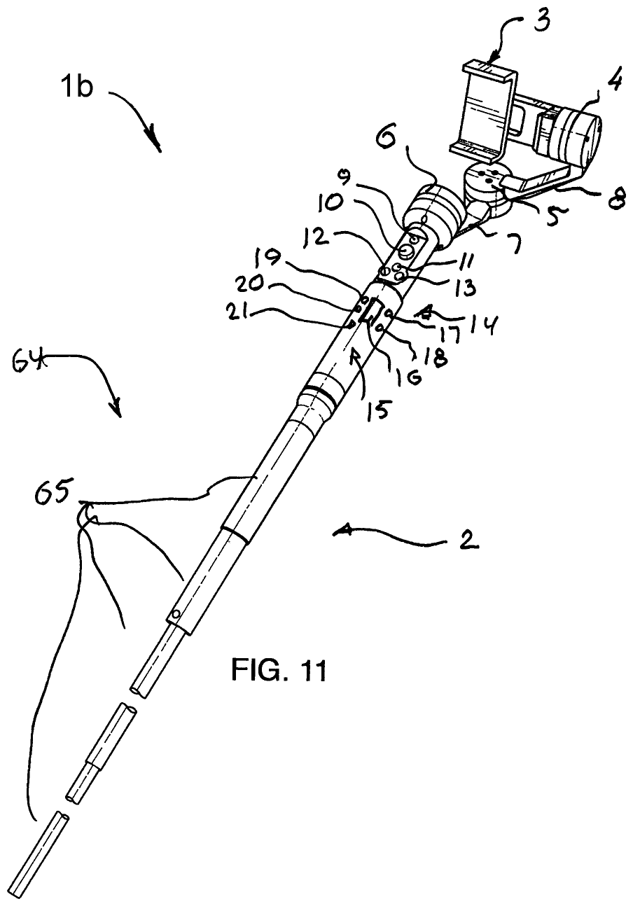

FIG. 11 of the drawings shows the device for supporting a smartphone having a camera or supporting a camera in accordance with a further feature of the present invention. The supporting device 1b has a handle 2 adapted to be held by a user and connected with a holder 3 for receiving and holding a not shown smartphone with a camera or receiving and holding an action camera. It further has a rolling motor 5, a tilting motor 4, and pan or yaw motor 6 for imparting corresponding movements to the holder 3 and thereby to a smartphone having a camera or to an action camera held in the holder 3. Arms 7 and 8 connect the corresponding motors with one another. The handle 2 is provided with an on/off power button 9 for turning the operation of the device 1 on or off, a joystick button 10 for controlling a video recording of the smartphone with a camera or of the action camera, an orientation button 11 for orienting the smartphone having a camera or for orienting the action camera, a button 12 for operating corresponding modes, and a button 13 for video and photo recording. The handle 2 is connected with a telescoping extension support 64 which can be held by a user and is composed of interconnected components 65 which are movable toward one another and away from one another to reduce or to increase he length of the support 64, for convenience of user's operation with the smartphone having a camera or with the action camera received in the holder 3.

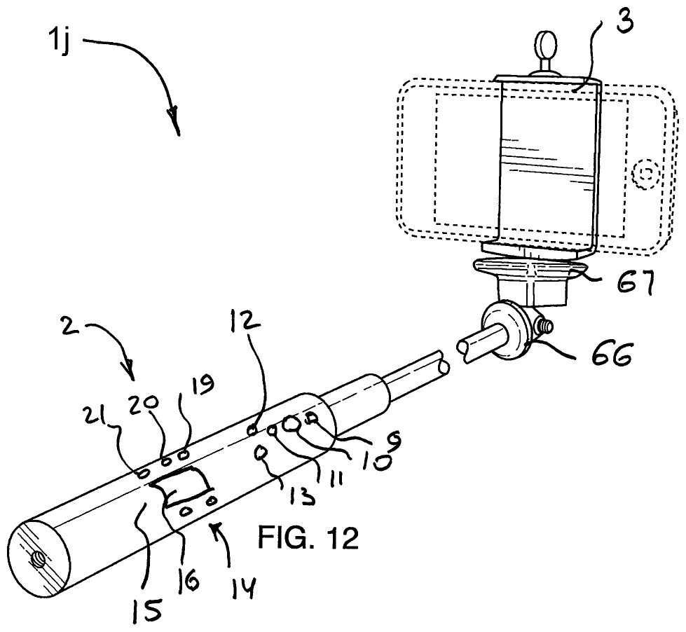

FIG. 12 of the drawings shows the device for supporting a smartphone having a camera or supporting a camera in accordance with a further feature of the present invention. The supporting device has a handle 2 adapted to be held by a user and connected with a holder 3 for receiving and holding a not shown smartphone with a camera or an action camera. The supporting device, similarly to the device of FIG. 1A for supporting a smartphone with a camera or supporting an action camera according to the invention the handle 2 has an additional portion which is identified with reference numeral 14 and provided with the components 15 allowing receiving audio signals from audio sources and reproducing them in the vicinity of the handle of the device and therefore in the vicinity of a supported smartphone with a camera or a supported camera before, during and after a recording by the camera. The handle 2 is this embodiment is telescoping and has a plurality of individual portions telescopingly connected with each other to increase or reduce the length of the handle 2. The individual portion which is the closest to the holder 3 has an element 66 which is turnably connected with an element 67 supporting the holder 3.

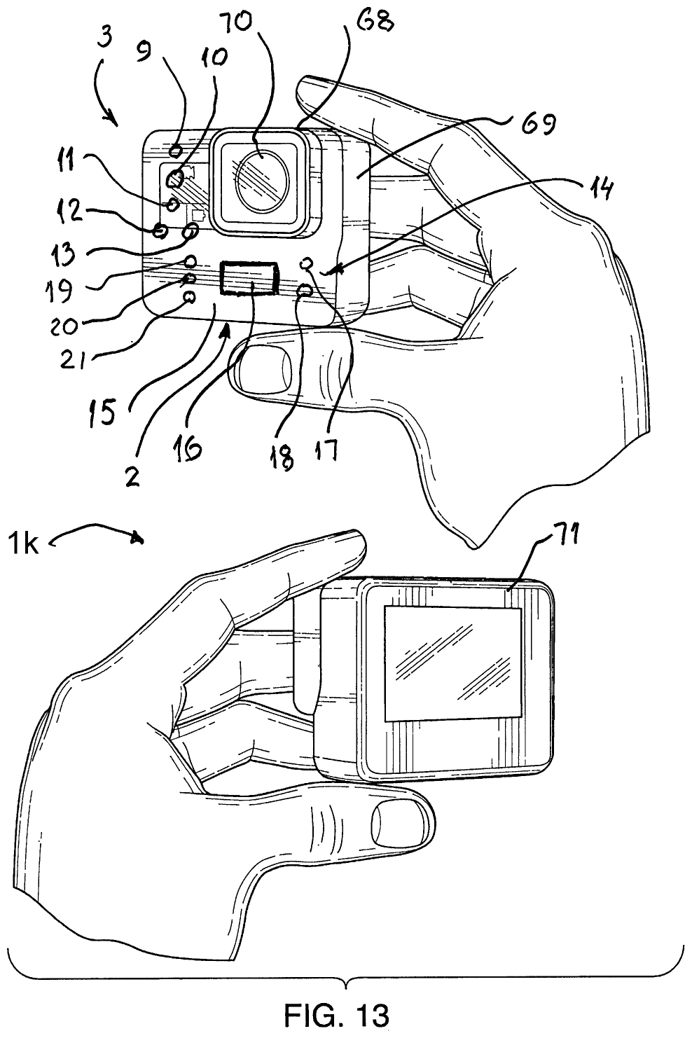

FIG. 13 of the drawings shows the device for supporting a camera 68 in accordance with a further feature of the present invention. The supporting device in this embodiment has a handle 2 formed as a casing 69 of the camera 68, which is shown from its front side on the right view and from its rear side on the left view. The camera 68 has a camera casing forming a holder 3, an objective 70 and a viewfinder display 71. The casing 69 of the camera 68 has a portion which is identified with reference numeral 14 and provided with the components 15 allowing receiving audio signals from audio sources and reproducing them in the vicinity of the handle of the device and thereby in the vicinity of the supported camera before, during and after recording by the supported camera, as in the embodiments of FIG. 1A.

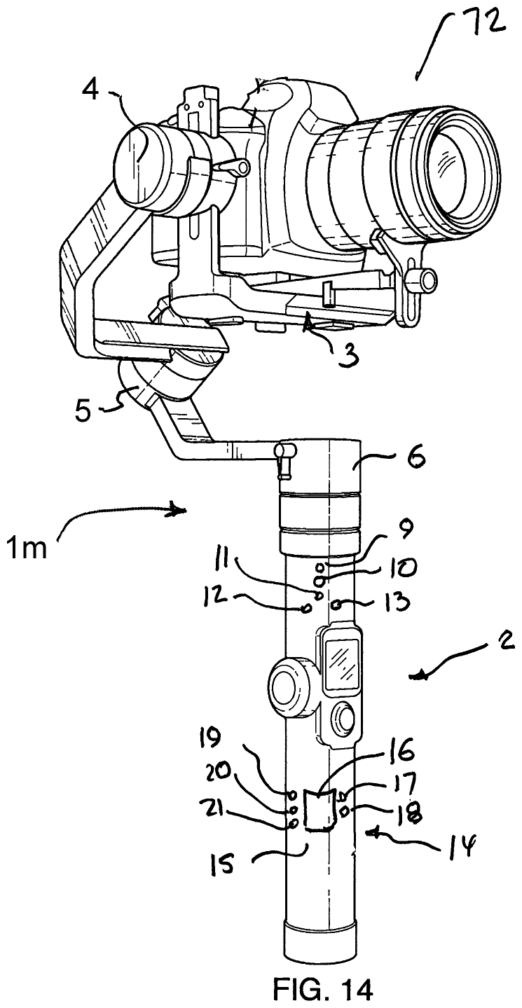

FIG. 14 shows the device for supporting a large camera 72 in accordance with a further feature of the present invention which is held in a holder 3. This device has components corresponding to the components of the device shown in FIG. 1A. In particular it has the three motors 4, 5, 6 and the holder 3. It also has the handle 2 with an additional portion which is identified with reference numeral 14 and provided with the same components 15 which allow receiving audio signals from audio sources and reproducing them in the vicinity of the device and therefore in the vicinity of the supported large camera before, during and after recording by the supported large camera.

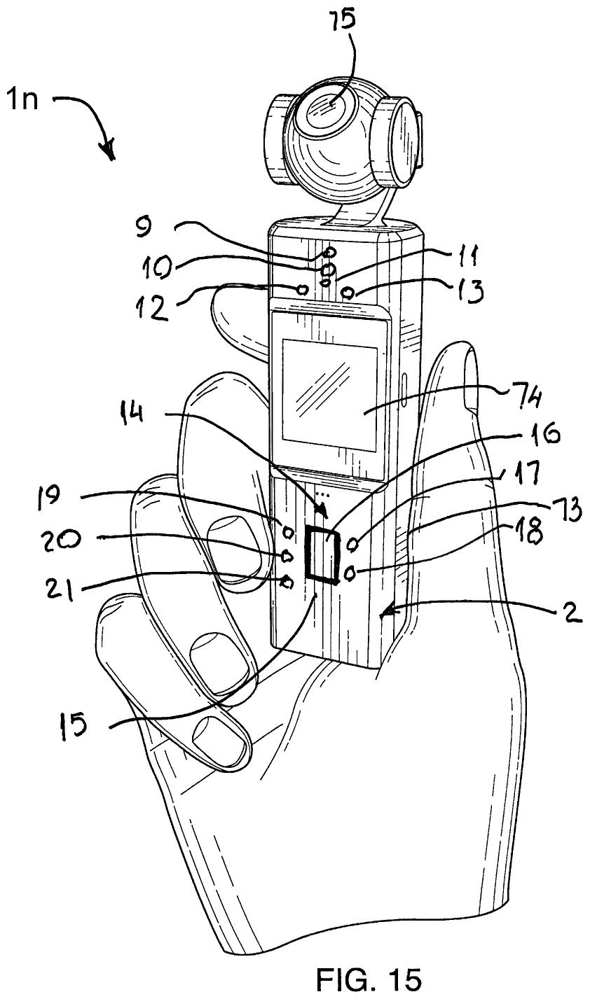

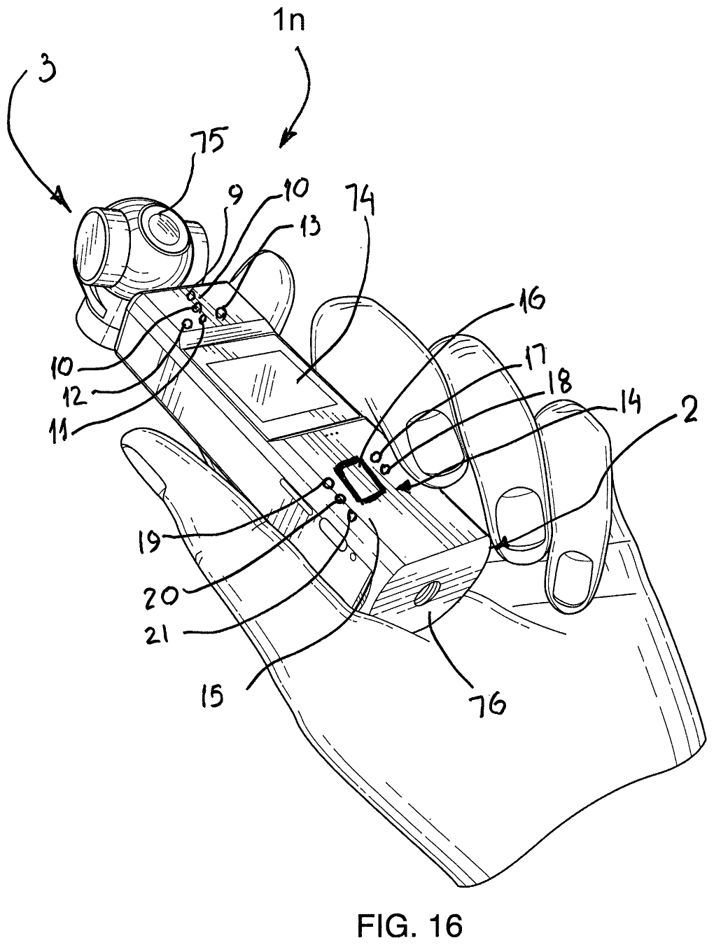

FIGS. 15 and 16 show a pocket-size device for supporting a camera in accordance with a further feature of the present invention. The device has a casing 73 with a portion which corresponds to the handle 2 and another portion which corresponds to the holder 3 of the device shown in FIG. 1A. A viewfinder with a touch screen is identified with reference numeral 74 and an objective is identified with reference numeral 75. The device further has a rolling motor 5, a tilting motor 4, and a pan or yaw motor 6 for imparting corresponding movements to the objective 75 of the camera. The supporting device has further components corresponding to the components of the device shown in FIG. 1A. In particular the casing 73 of the device has a portion which is identified with reference numeral 14 and provided with the same components 15 which allow receiving audio signals from audio sources and reproducing them in the vicinity of the handle 2, during and after recording by the supported camera. The handle 2 of the device further has a lower portion with a thread 76 for connecting to a support, such as a monopod, a tripod or the like.

The present invention is not limited to the details shown since various modification and structural changes are possible without departing from the spirit of the invention.

What is desired to be protected by Letters Patent is set forth in particular in the appended claims.

1. A device for supporting a smartphone having a camera or supporting an action camera, comprising
a holder supporting the smartphone having the camera that provides for shooting and recording video or supporting the action camera that provides for shooting and recording video;
a handle configured to be held by a user and connected with said holder; and
means provided in the handle for receiving audio signals from an audio signal source and reproducing the received audio signals in the vicinity of the handle during recording by the camera, so that the video recording and the receiving of the audio signals can be are actuated at the same time, and therefore the video recorded by the camera includes the received audio signals.

2. A device for supporting a smartphone having a camera or supporting an action camera as defined in claim 1, and further comprising at least two motors arranged between the handle and the holder and operative for moving the holder and thereby moving the smartphone with a camera held in the holder or moving a camera held in the holder relative to the handle for stabilizing a position of the smartphone with a camera or a position of the camera.

3. A device for supporting a smartphone having a camera or supporting an action camera as defined in claim 1, and further comprising means for selecting the outside audio signal source for receiving the audio signals from the selected outside audio signal source and reproducing the received audio signal in the vicinity of the handle; and means for controlling a position of the smartphone having the camera or a position of the action camera, wherein the handle is elongated, said means for selecting and said means for controlling being both located on the handle at two different locations which are spaced from each other as considered in a direction of elongation of the handle.

4. (canceled)

5. A device for supporting a smartphone having a camera or supporting an action camera as defined in claim 1, wherein said means include a screen display for showing wavelengths of the audio signals, adjusting buttons for adjusting a volume of received radio signals up and down correspondingly, a knob for switching between AM radio waves and FM radio waves of the audio signals, a knob for dialing a corresponding wavelength within an AM and FM ranges of the audio signals, and a knob for adjusting a volume of a speaker which generates corresponding audio signals.

6. A device for supporting a smartphone having a camera or supporting an action camera as defined in claim 1, wherein said means include a receiver selected from the group consisting of an AM receiver and an FM receiver, a transmitter selected from the group consisting of an AM transmitter and an FM transmitter, and a speaker.

7. (canceled)

8. A device for supporting a smartphone having a camera or supporting an action camera as defined in claim 6, and further comprising at least two motors arranged between the handle and the holder and operative for moving the holder and thereby the smartphone with a camera held in the holder or a camera held in the holder relative to the handle for stabilizing a position of the smartphone with a camera or a position of the camera.

9. A device for supporting a smartphone having a camera or supporting an action camera as defined in claim 7, and further comprising at least two motors arranged between the handle and the holder and operative for moving the holder and thereby the smartphone with a camera held in the holder or a camera held in the holder relative to the handle for stabilizing a position of the smartphone with a camera or a position of the camera.

10. A device for supporting a smartphone having a camera or supporting an action camera as defined in claim 1, wherein said means include an antenna for transmitting and receiving radio signals, a receiver circuitry and a transmitter circuitry both connected to a processor circuitry, and a control processor which controls an operation said means, a microphone, a keypad, and a display.

11. A device for supporting a smartphone having a camera or supporting an action camera as defined in claim 1, wherein said handle is provided with an opening for attaching the device to a support and having an inner thread for screwing in a threaded end of the support, wherein the opening being provided in a part connectable with a remaining part of the handle by a threaded connection.

12. A device for supporting a smartphone having a camera or supporting an action camera as defined in claim 1, and further comprising a part which has a threaded portion provided with an outer thread and screwable into a lower part of the handle which is hollow and provided with an inner thread, and the handle having an inner opening which is exposed when the part is unscrewed and removed from a remaining part of the handle and which is used for inserting of a battery.

13. A device for supporting a smartphone having a camera or supporting an action camera as defined in claim 2, wherein the handle is connected with remaining components of the device via a multi-part telescoping connecting unit composed of a plurality of handle elements which are telescopingly connectable with one another and are displaceable relative to one another, so that by extending or retracting of the telescoping connecting unit a distance of the holder from the handle can be reduced or increased.

14. A device for supporting a smartphone having a camera or supporting an action camera as defined in claim 1, and further comprising a tilting motor and a rolling motor applying correspondingly a tilting movement and a rolling movement to the holder, and a foldable arm having one end connected with the tilting motor and another opposite end which is pivotably connected with the pan motor so that the device can be folded to occupy a substantially small space, which can be convenient for its storage and transportation.

15. A device for supporting a smartphone having a camera or supporting an action camera as defined in claim 1, and further comprising a rolling motor, a tilting motor, and a pan or yaw motor for imparting corresponding movements to the holder; a multi-part telescoping connecting unit composed of a plurality of elements which are telescopingly connectable with one another and are displaceable relative to one another and connects the handle with the pan or yaw motor so that by extending or retracting of the telescoping connecting unit a distance from the holder to the handle can be reduced or increased; and a foldable arm having one end connected with the tilting motor and another opposite end pivotably connected with the pan motor, so that the device can be folded to occupy a substantially small space which can be convenient for its storage and transportation.

16. A device for supporting a smartphone having a camera or supporting an action camera as defined in claim 1, and further comprising a rolling motor and a tilting motor for imparting corresponding movements to the holder and thereby to a smartphone or to an action camera held in the holder, wherein the handle has a substantially rectangular cross section and an additional portion provided with said components which allow receiving audio signals from audio sources and reproducing them in the vicinity of the handle and therefore in the vicinity of a supported smartphone having a camera or of a supported camera before, during and after recording by a supported camera.

17. A device for supporting a smartphone having a camera or supporting an action camera as defined in claim 1, wherein the holder includes a housing which has an additional portion provided with components which allow receiving audio signals from audio sources and reproducing them in the vicinity of the handle and therefore in the vicinity of a supported smartphone having a camera or of a supported camera before, during and after recording by the camera, the housing being supported on a tripod having adjustable legs, connected with the housing via a ball joint and fixed by a screw in its desired position.

18. A device for supporting a smartphone having a camera or an action camera as defined in claim 1, and further comprising a rolling motor, a tilting motor, and pan or yaw motor for imparting corresponding movements to the holder, and arms connecting the corresponding motors with one another, wherein the handle is provided with an on/off power button for turning the operation of the device on or off, a joystick button for controlling the movement of the smartphone or of the action camera, a button for operating corresponding modes, and a button for video and photo recording, the handle capable of being supported on a tripod.

19. A device for supporting a smartphone having a camera or supporting an action camera as defined in claim 1, and further comprising a rolling motor, a tilting motor, and pan or yaw motor for imparting corresponding movements to the holder, arms connecting the corresponding motors with one another, the handle being provided with an on/off power button for turning the operation of the device on or off, a joystick button for controlling the movement of the smartphone or the action camera, a button for operating corresponding modes, and a button for video and photo recording, the handle having a built in telescoping extension support composed of interconnected components which are movable toward one another and away from one another to reduce or to increase a length of the support, for convenience of user's operation with the smartphone having a camera or with an action camera received in the holder.

20. A device for supporting a smartphone having a camera or supporting an action camera as defined in claim 1, wherein the handle has an additional portion provided with the components allowing receiving audio signals from audio sources and reproducing them in the vicinity of the device and therefore in the vicinity of a supported smartphone having a camera or of a supported camera before, during and after recording by a supported camera, the handle being telescoping and has a plurality of individual portions telescopingly connected with each other to increase or reduce the length of the handle, with one of the individual portions which is the closest to the holder having an element which is turnably connected with an element supporting the holder.

21. A device for a smartphone having a camera or supporting an action camera, comprising a holder supporting the smartphone having a camera or supporting the action camera; a handle configured to be held by a user and connected with said holder; and means for receiving audio signals from an audio signal source and reproducing the received audio signals in the vicinity of the handle during recording by the camera, and further comprising a casing supporting a camera and forming the holder, the casing having an objective and a viewfinder display and having a portion provided with the components which allow receiving the audio signals from the audio source and reproducing them in the vicinity of the device during recording by the supported camera.

22. A device for supporting a smartphone having a camera or an action camera as defined in claim 1, wherein the handle has an additional portion and provided with the components which allow receiving audio signals from audio sources and reproducing them in the vicinity of the device and designed for supporting of the camera which is a large camera.

23. A device for supporting a smartphone having a camera or supporting an action camera, comprising a holder supporting the smartphone having a camera or supporting the action camera; a handle configured to be held by a user and connected with said holder; and means for receiving audio signals from an audio signal source and reproducing the received audio signals in the vicinity of the handle during recording by the camera, wherein the device is constructed as a pocket-size device with a casing which forms the handle of the device, the casing having a viewfinder with a touch screen and an objective, a rolling motor, a tilting motor, and pan or yaw motor for imparting corresponding movements to an objective of the camera and having a portion provided with the components which allow receiving the audio signals from the audio source and reproducing them in the vicinity of the device, and another portion with a thread for connecting to a support.

24. A device for supporting a smartphone having a camera or supporting an action camera as defined in claim 3, wherein said means for selecting the outside audio signal source for receiving the audio signals from the selected outside audio signal source and reproducing the received audio signal in the vicinity of the handle are located on the handle between said holder and said means for controlling a position of the smartphone having the camera or a position of the action camera.

25. A device for supporting a smartphone having a camera or supporting an action camera, comprising
a holder supporting the smartphone having a camera that provides for shooting and recording a video or supporting an action camera that provides for shooting and recording a video;
a handle configured to be held by a user and connected with said holder; and
means provided in the handle for receiving audio signals from an audio signal source and reproducing the received audio signals in the vicinity of the handle during recording by the camera, thereby allowing the recording of the video and the receiving of the audio signals at the same time.

26. A device as defined in claim 25, and further comprising a speaker which reproduces the received audio signals, adjusting buttons for adjusting up or down the volume of the received audio signals reproduced in the speaker, and a separate knob for adjusting the volume of the speaker which reproduces the audio signals.
